(19) United States
(12) Patent Application Publication
(10) Pub. No.: US 2009/0021075 A1
(43) Pub. Date: Jan. 22, 2009

(54) Semiconductor device

(75) Inventor: Katsumaru Ohno, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/216,955

(22) Filed: Jul. 14, 2008

(30) Foreign Application Priority Data
Jul. 20, 2007 (JP) 189551/2007

(51) Int. Cl. H02J 3/14

(52) U.S. Cl. 307/31

(57) ABSTRACT

To reduce power consumption of a semiconductor device, the semiconductor device is configured to include: a power supplier for outputting multiple different voltages; a power controller for outputting a control signal to cause the power supplier to output one of the multiple voltages; a voltage controlling target block for outputting an error detection signal indicating an operation state, in accordance with the multiple voltages; and an error detector for monitoring the operation of the voltage controlling target block. The error detector determines, based on the error detection signal, whether the operation of the voltage controlling target block is normal, and informs the power controller of the obtained determination result. Further, based on a voltage indicated by a control signal and on the determination result from the error detector, the power controller determines a voltage controlling target block voltage to be supplied to the voltage controlling target block.

### BACKGROUND OF THE INVENTION

1. Field of the Invention

The present invention relates to a semiconductor device, and, more particularly, relates to a technique for reducing power consumption of a semiconductor device.

2. Description of the Related Art

Various electronic apparatuses including semiconductor devices have been in widespread use. Semiconductor integrated circuits are mounted on semiconductor devices included in electronic apparatuses. To cope with growing demand for higher functionality and higher performance of electronic apparatuses, the scale of semiconductor integrated circuits to be mounted thereon has become larger and larger. With an increase in the scale and integration of semiconductor integrated circuits, the power consumption of the circuits is also increasing. In contrast, there has been demand for electronic apparatuses operating at low power consumption. In order to meet this demand, research and development have been being conducted every day to reduce power consumption of semiconductor devices.

FIG. 1 is a block diagram showing a configuration of a conventional semiconductor device (101). The semiconductor device (101) is configured to include: a power controller (102); a power supplier (103) ;and a circuit block (104). An operation guaranteed voltage (116) is supplied from the power supplier (103) to the circuit block (104). The power supplier (103) generates the operation guaranteed voltage (116) based on a power control signal (111) supplied from the power controller (102).

The operation guaranteed voltage (116) is determined, in the design phase, in consideration of characteristic variations such as: the one occurring when the power supplier (103) is manufactured; the one caused by a change in environmental temperature of the semiconductor device (101); and the one based on usage. The power controller (102) controls the power supplier (103) based on the power control signal (111), and outputs the operation guaranteed voltage (116) which is determined in the design phase. The power supplier (103) supplies the operation guaranteed voltage (116), which keeps out of the occurrence of some errors in the semiconductor device (101) in signal transmission, to the circuit block (104) of the semiconductor device (101).

Further, besides the above-described technique, other techniques on the power supplies of semiconductor devices have been known (see, for example, Japanese Patent Application Publication No. 2006-120686 (Patent Document 1) and No. Hei 5-251652 (Patent Document 2)). In a technique described in Patent Document 1, an LSI includes a circuit for detecting an amount of performance variation due to a variation of the LSI. Thus, a supply voltage to the LSI is controlled based on an output value of this circuit.

Patent Document 2 discloses a technique for enabling a CMOS integrated circuit to operate at predetermined speed and power consumption even if the transistors in the CMOS integrated circuit each have a very fine gate length (0.2 to 0.3 micrometer) Patent Document 2 describes, as an element of its technique, an optimum power voltage determination circuit including a power voltage control circuit connected to a power circuit. The power voltage control circuit selects the optimum power voltage to be applied to the polysilicon gate, and this selection is made based on enumeration data of a transmission frequency from a counter circuit. The power circuit generates the optimum voltage, which is selected by the power voltage control circuit, from a high voltage part of an external power input terminal.

In recent years, electronic apparatuses which equip terminal functions, such as cellular telephones and PDAs (Personal Digital Assistances), and electronic apparatuses such as portable media players and digital cameras have been rapidly in widespread use. Semiconductor devices included in such portable electronic apparatuses operate with power supplied from a battery. There are known techniques on a power supply of a semiconductor device in a portable electronic apparatus (see, for example, Japanese Patent Application Publication No. 2002-353799 (Patent Document 3)).

In Patent Document 3, a technique on a semiconductor integrated circuit and a driving method thereof is disclosed. Here, the semiconductor integrated circuits operate at high speed without introducing errors even when the operation characteristics of a circuit changes. In the technique disclosed in Patent Document 3, clock signal and a malfunction signal are inputted into a power voltage control circuit. Further, the power voltage control circuit counts the numbers of pulses of the clock signal and the malfunction signal, respectively.

The power voltage control circuit counts the number of pulses of the malfunction signal per hour, when the number of pulses of the clock signal per hour reaches a certain number of times. When the counted number exceeds a certain number of times (an upper limit of a malfunction), the power voltage control circuit transmits a control signal, for increasing the power voltage, to the power circuit. Further, when the counted number does not reach a certain number of times (a lower limit of a malfunction), the power voltage control circuit transmits a signal, for increasing the power voltage, to the power circuit.

In terms of each of the techniques described in Patent Documents 1 and 2 and the semiconductor device (101), the operation guaranteed voltage (116) is determined, in the design stage, in consideration of characteristic variations such as: the one occurring when the power supplier (103) or the like is manufactured; the one caused by a change in environmental temperature of the semiconductor device 101; and the one based on usage. Further, in each one of the techniques described in Patent Documents 1 and 2 and the semiconductor device 101, the operation guaranteed voltage (116) determined in the design stage is supplied to a circuit block (e.g., the circuit block 104) that is to be supplied with power. This operation guaranteed voltage (116) is a voltage obtained by adding various types of margins to the minimum necessary voltage in order to guarantee operations. Because of such margins, power is unnecessarily consumed in the techniques described in Patent Documents 1 and 2, and the semiconductor device (101).

Further, in the technique described in Patent Document 3, for the purpose of error detection, a voltage control target block includes functionally-necessary sequential circuits, and also with additional sequential circuits as means for detecting errors occurring when a voltage is adjusted. Here, the number of additional sequential circuits is the same as that of the functionally-necessary sequential circuits. The additional sequential circuits must be disposed to have the same transport delay time as that of the functionally-necessary sequential circuits. If there is a difference between the additional sequential circuits and the functionally-necessary sequential circuits in the transport delay time, an error detection effect which is an object of the additional sequential circuits cannot be obtained. Therefore, the technique described in Patent Document 3 has a problem that a complicated configuration is required to mount the circuits necessary for detecting errors, and that electricity is constantly consumed in the additional sequential circuits.

### SUMMARY

Means for solving the above-described problems will be described below using the same reference numbers as those used in the “Preferred Embodiments.” The reason why these reference numbers are used below is to clarify correspondences between the descriptions of “Claims” and those of the “Preferred Embodiments.” However, these reference numbers must not be used to interpret the scope of the inventions described in “Claims.”

To solve the above-described problems, a semiconductor device (1) includes: a voltage controlling target block (4) outputs error detection signals (13) in accordance with respective multiple voltages to be supplied from a power supplier (3); and a power controller (2) outputs one of the multiple voltages to the power supplier (3) based on the error detection signals (13).

The semiconductor device (1) may further include an error detector (5) monitors an operation of the voltage controlling target block (4). In this case, the error detector (5) determines whether the operation of the voltage controlling target block (4) corresponding to the error detection signal (13) is normal, and informs the power controller (2) of a determination result (14) thus obtained. Further, the power controller (2) outputs a control signal (11) for outputting one of the multiple voltages, and based on a voltage (14) indicated in a control signal (11) and on the determination result (14) from the error detector (5), the power controller (2) determines a voltage controlling target block voltage.

More specifically, to solve the above-described problems, a supply voltage is determined based on a signal transmission error occurring in an ASIC. In this case, a power-save-time counting counter is configured in the ASIC. A supply voltage to this power-save-time counting counter is adjusted while power is increased. In this adjustment, a lower limit voltage at which the counter normally operates is determined. At the time of power saving, an obtained lower limit voltage is supplied to the power-save-time counting counter.

AS described above, in the techniques described in Patent Documents 1, 2, in addition to a voltage for guaranteeing a minimal operation, a voltage to which various types of margins (e.g., a voltage in view of time degradation) are added is determined in advance, and that voltage is supplied. Accordingly, for example, when a voltage of 3 volts is applied to a circuit which operates at 2.5 volts, excessive power corresponding to the excessive voltage supplied to the circuit is consumed. In the semiconductor device (1) of an embodiment of the present invention, a voltage at which operation of a present circuit is secured without considering time degradation can be properly supplied. For example, to a circuit operating at 2.5 volts, a voltage of 2.5 volts can be supplied so that power consumption can be reduced.

Further, the semiconductor device of the present invention restrains power consumption growth, and determines a supply voltage by causing a block which determines a supply voltage to cyclically operate at the time of determining a voltage, without causing the block to constantly operate. Further, an error detection means, which operates at the time when determining a supply voltage, is set as a separate block different from a block determining a supply voltage. Thus, in the semiconductor device of the present invention, a constraint to transport delay time is relaxed.

### BRIEF DESCRIPTION OF THE DRAWINGS

FIG. 1 is a block diagram shows a configuration of a conventional semiconductor device;

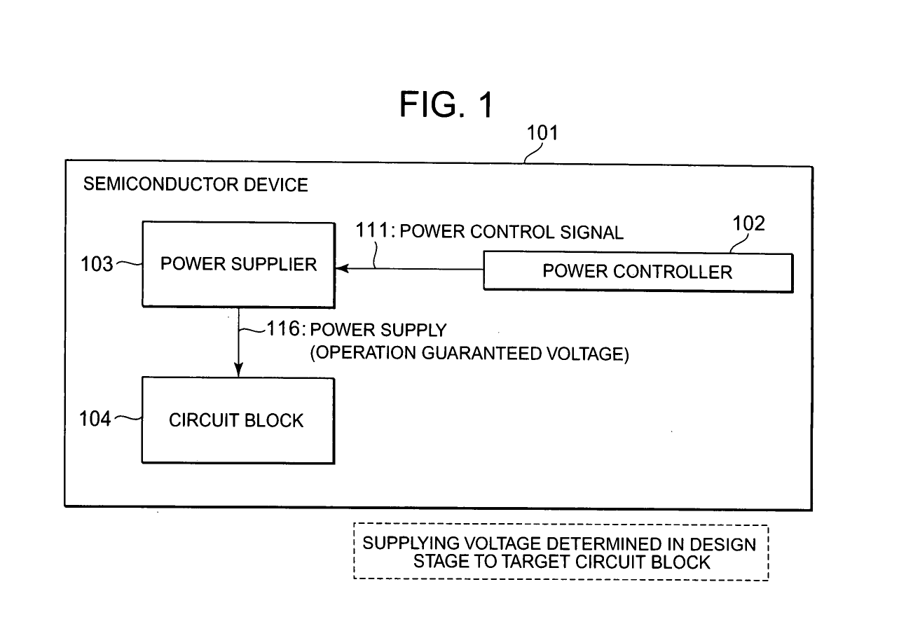

FIG. 2 is a block diagram shows a conceptual configuration of a semiconductor device of the present invention;

FIG. 3 is a block diagram shows a configuration of a semiconductor device of an embodiment;

FIG. 4 is a flowchart shows operation of determining an operational lower limit voltage; and

FIG. 5 is a flowchart shows generation operation of an error detection result (14).

### DETAILED DESCRIPTION OF THE PREFERRED EMBODIMENTS

An embodiment of the present invention will be described below with reference to the accompanying drawings. The present embodiment will be described below referring to an example of a semiconductor device which is provided to an electronic device, such as a cellular telephone or the like, operating with a battery. Further, in the embodiment below, the semiconductor device (1) is assumed to have two modes, a normal mode and a standby mode.

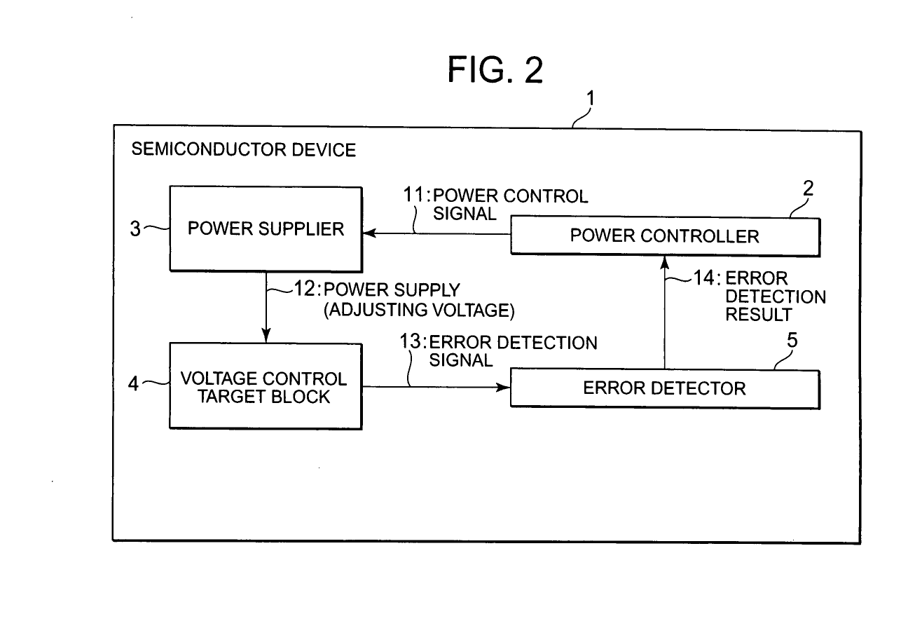

FIG. 2 is a block diagram illustrating a conceptual configuration of the semiconductor device of this embodiment. Referring to FIG. 2, the semiconductor device (1) is configured to include: a power controller (2); a power supplier (3); a voltage controlling target block (4); and an error detector (5).

The power controller (2) supplies a power control signal (11) to the power supplier (3). The power control signal (11) is a signal for setting voltages to be supplied to respective blocks in the semiconductor device (1). The power supplier (3) outputs an adjustment voltage (12) determined based on the power control signal 11. For example, a supply voltage to the voltage controlling target block (4) is changed depending on the normal mode or the standby mode. In this embodiment, a voltage of the voltage controlling target block (4) is to be adjusted.

The error detector (5) receives a count value (13) output from the voltage controlling target block (4). The error detector (5) informs the power controller (2) of whether the voltage controlling target block (4) operates properly at a present adjustment voltage (12) based on the count value (13). The power controller (2) outputs the power control signal (11) for changing a supply voltage to the voltage controlling target block (4). In this manner, a lower limit of an operation compensation voltage of the voltage controlling target block (4) is determined so that an effect of low power consumption can be obtained.

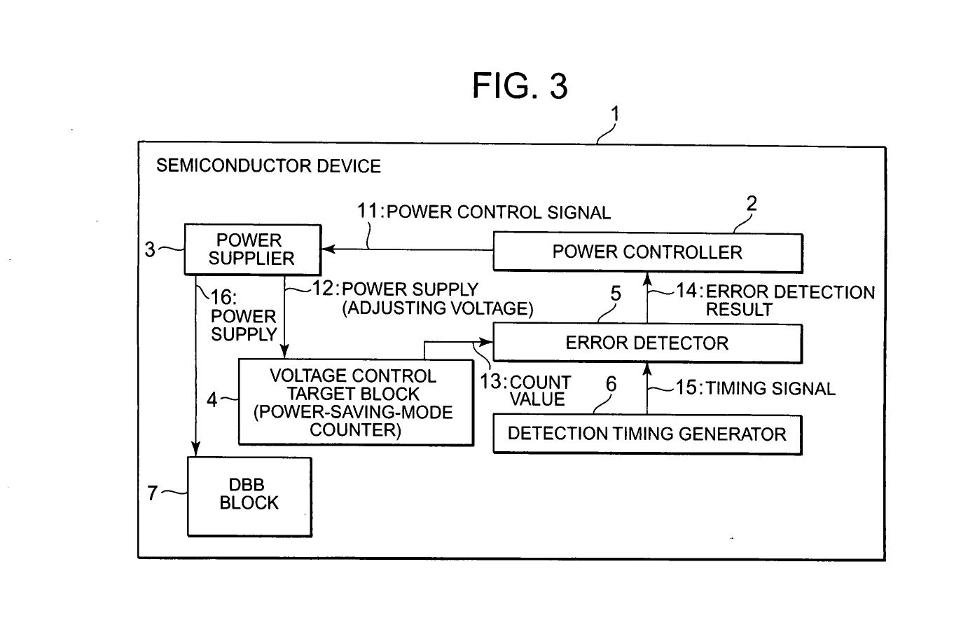

FIG. 3 is a block diagram shows a configuration of the semiconductor device (1) when the voltage controlling target block (4) serves as a power-saving-mode counter. Referring to FIG. 3, it can be found that the semiconductor device (1) further includes a detection timing generator (6) and a DBB block (7), in addition to the configuration showing in FIG. 2.

The detection timing generator (6) supplies, to the error detector (5), the timing at which the count value (13) should be latched. The DBB block (7) is a circuit block operates independently of the voltage controlling target block (4). In other words, a path through which a voltage is supplied from the power supplier (3) to the DBB block (7) is configured independently of a path through which a voltage is supplied from the power supplier (3) to the voltage controlling target block (4).

The voltage controlling target block (4) is a block counting time for which power is saved, and has a function for generating a trigger signal which releases power saving after the passage of time of power saving elapses. The power supplier (3) is a functional block configured to supply power to the voltage controlling target block (4) and to other blocks (e.g., a circuit block such as the DBB block (7)). The power supplier (3) determines a supply voltage to the voltage controlling target block (4) and the DBB block (7) based on the power control signal (11) supplied from the power controller (2).

The error detector (5) receives a count value to be output from the voltage controlling target block (4), as the count value (13). The error detector (5) latches count values at start timing or ending timing informed from the detection timing generator (6). The error detector (5), within a period from the start timing to the ending timing, compares an amount of counting-up with an expected value of the amount of counting-up. The error detector (5) supplies to the power controller (2), an error detection result (14) showing whether a compared result thus obtained is in agreement or in disagreement.

The power controller (2) supplies the power control signal (11) to the power supplier (3). The power control signal (11) is a signal for setting a voltage to be supplied to a predetermined circuit block in the semiconductor device (1). When determining a voltage to be supplied from the power supplier (3) to the voltage controlling target block (4), the power controller (2) generates the power control signal (11) based on the error detection result (14) informed from the error detector (5).

A more specific configuration and operation of this embodiment will be described below. In the following description, an apparatus includes the semiconductor device (1) is exemplified. Here, the apparatus equips a normal operation (power up) mode as well as a standby (power save) mode, and operates intermittently (e.g., a wireless communication terminal such as a cellular phone). When included in such a wireless communication terminal, the semiconductor device (1) provides, to the terminal, a function which regularly monitors a communication state between the terminal and a base station. This function is performed by switching between the power up mode and the power saving mode. The semiconductor device (1) described below includes: the voltage controlling target block (4); and the DBB (Digital Basic Block) block (7). Further, the semiconductor device (1) includes the detection timing generator (6).

When an electronic apparatus including the semiconductor device (1) equips an intermittent operation function, the semiconductor device (1) counts the time of standby (power save) mode (hereinafter, this time is referred to as power save time) The power save time is counted by the power-saving-mode counter, which is included in the semiconductor device (1). In the following description, this embodiment will be described for the case where the power-saving-mode counter, which counts power save time, is the voltage controlling target block (4).

Here, the power supplier (3) includes a function capable of adjusting a voltage to be supplied to the power-saving-mode counter which is a voltage control target, separately from other blocks (e.g., DBB block (7)).

The power-saving-mode counter which is the voltage controlling target block (4) does not perform a measuring operation of the power save time, in the normal operation mode as described-above. Only in the power saving mode, it is required to count of the power save time. Therefore, the power supplier (3) of the semiconductor device (1) of this embodiment changes (n ways) a voltage of the power-saving-mode counter which is the voltage controlling target block (4), in the normal operation mode in which it is not necessary to measure the power save time.

When a voltage supplied from the power supplier (3) is beyond a range in which the power-saving-mode counter is caused to normally operate, the outputting of a normal count value from the power-saving-mode counter comes to be no longer performed. For example, if a circuit in power saving mode is configured so that the counter outputs “10” per second as a count value, when a supplied voltage is beyond a normal operation range, the counter cannot output the count value “10” any more. The semiconductor device (1) determines, in the normal operation mode, a lower limit voltage necessary for the power-saving-mode counter to output a normal operation result (e.g., the count value “10”). Further, the semiconductor device (1) supplies the lower limit voltage determined when moving to the standby mode, to the power-saving-mode counter. Incidentally, to other functional blocks in which switching between the normal operation mode and the standby mode is not performed, voltages suitable for the respective blocks are supplied without relying on any voltage output from the power-saving-mode counter.

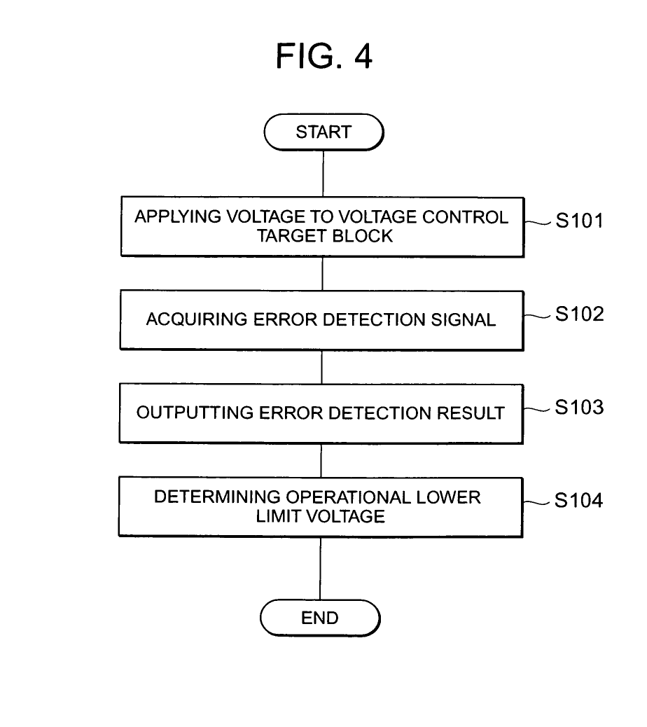

FIG. 4 is a flowchart shows an operation of determining an operational lower limit voltage. Referring to FIG. 4, in Step S101, a predetermined voltage is applied to the power-saving-mode counter. In Step S102, the error detector (5) acquires an error detection signal (13) output from the power-saving-mode counter. In Step S103, based on the error detection signal (13), the error detector (5) determines whether the voltage controlling target block (4) is operating normally, and outputs a determination result thus obtained as the error detection result (14). In Step S104, the power controller (2) determines the operational lower limit voltage based on the error detection result (14). Thereafter, in the power saving mode, the power supplier (3) supplies the voltage value determined in the previous procedure to the power-saving-mode counter.

The voltage controlling target block (4) outputs count values (13) in response to voltage of varied values. The error detector (5) determines whether the voltage controlling target block (4) is operating normally, based on multiple error detection signals (13) to be outputted. The semiconductor device (1) repeatedly performs this operation at a fixed period. Accordingly, the supplied voltage of the power-saving-mode counter, the voltage controlling target block (4), is updated at a fixed period in power up mode.

Operation for generating the above-described error detection result (14) will be described. The error detection result (14) of this embodiment is generated by the error detector (5). The error detector (5) acquires a count up value in the case where the power-saving-mode counter has been caused to operate for a certain period of time (Δt), from the voltage controlling target block (4). Based on the acquired count up value, the error detector (5) determines whether the voltage controlling target block (4) is operating normally. To be more specific, the error detector (5) retains in advance the expected value of the amount of counting-up for a certain period of time (Δt). The error detector (5) calculates a difference between a count value at a timing when a start trigger is supplied from the detection timing generator 6, and another count value at a timing when an ending trigger is supplied from the detection timing generator 6.

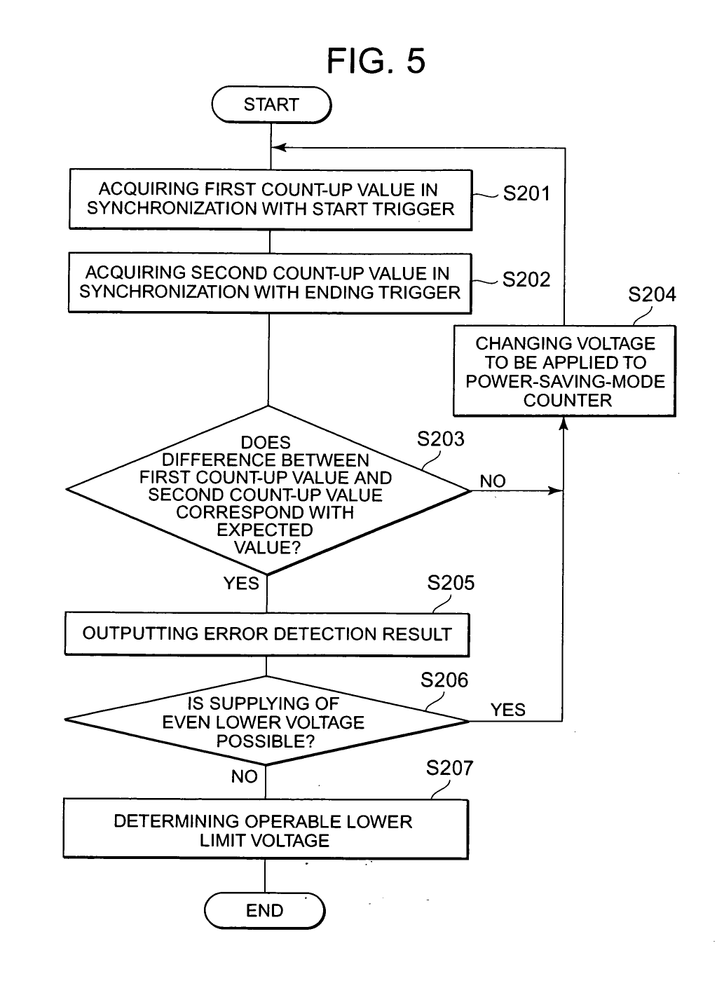

FIG. 5 is a flowchart shows an generating operation of the error detection result (14). Referring to FIG. 5, in Step S201, the error detector (5) acquires the count value at the timing when the start trigger is supplied, as a first count-up value. In Step S202, the error detector (5) acquires the count value at the timing when the ending trigger is supplied, as a second count-up value.

In Step S203, the error detector (5) calculates a difference between the first count-up value and the second count-up value. The error detector (5) determines whether the difference corresponds with the expected value. Next, when the difference doesn't correspond with the expected value, the process moves to Step S204. In Step S204, the error detector (5) supplies, to the power controller (2), a signal indicating that the difference does not correspond with the expected value. In response to the signal, the power controller (2) instructs the power supplier (3) to change the voltage to be applied to the power-saving-mode counter.

Further, when the result determined in Step S203 shows that the difference corresponds with the expected value, the process moves to Step S205. In Step S205, the error detector (5) supplies, to the power controller (2), the error detection result (14) showing that the difference corresponds with the expected value.

In Step S206, the power controller (2) determines whether a supply of a lower voltage than the present voltage is possible. As the determination result, when a lower voltage than the present voltage can be supplied, the process moves to Step S204. In Step S207, when the present voltage is a lowest voltage ensuring the operation of the voltage controlling target block (4), the power controller (2) sets the voltage to be an operational lower limit voltage. In this manner, the error detector (5) determines whether the voltage controlling target block (4) is operating normally, depending on whether the difference corresponds with the expected value.

The voltage controlling target block (4) of this embodiment is a circuit mainly operating in the standby mode. In this case, it is sufficient for the voltage controlling target block (4) to operate at the time of voltage determination in the normal operation mode. Further, even when the voltage determining operation is repeatedly performed at a constant period, it is sufficient for the voltage controlling target block (4) to operate at that period. Therefore, an operation voltage of the voltage controlling target block (4) can be determined without increasing power consumption.

Further, when a voltage to be supplied to the voltage controlling target block (4) is determined, the error detection result (14) is generated by the error detector (5) which is a circuit block configured independently with the voltage controlling target block (4). Thus, the voltage being supplied to the voltage controlling target block (4) can be determined without depending on transport delay time. For a semiconductor device (1) intermittently operating with a battery of a cellular phone or the like, the semiconductor device 1 of this embodiment is capable of producing a high effect for reducing the power consumption thereof. Further, the semiconductor device (1) thereof is capable of performing error detection without configuring complicated circuits.

In the above-described embodiment, the voltage controlling target block (4) exemplifies the power-saving-mode counter, and the configuration and operation of the voltage controlling target block (4) have been described. This, however, does not mean that the voltage controlling target block (4) is limited to be the power-saving-mode counter. The technique of this embodiment is applicable to a circuit block which is required to stably operate in the standby mode, and which does not influence the entire device even when being unstable in the normal operation mode. Further, when a voltage to be supplied (in the normal operation mode) changes stepwise, the technique of this embodiment is applicable to a circuit block which outputs a different output signal based on its voltage.

It is apparent that the present invention is not limited to the above embodiments, but may be modified and changed without departing from the scope and spirit of the invention.

What is claimed is:

1. A semiconductor device comprising:
a voltage controlling target block which outputs error detection signals according to a plurality of respective voltages supplied from a power supplier; and
a power controller which outputs one of the plurality of voltages to the power supplier, wherein the power controller determines a voltage controlling target block voltage to be supplied to the voltage controlling target block based on the error detection signal.

2. The semiconductor device according to claim 1, further comprising:
an error detector which determines, based on the error detection signal, whether an operation of the voltage controlling target block is normal, wherein
the power supplier outputs one of the plurality of voltages in response to a control signal supplied from the power controller,
the voltage controlling target block outputs the error detection signal to the error detector in response to a voltage supplied from the power supplier,
the error detector informs the power controller of a determination result as to whether the operation of the voltage controlling target block is normal, and
the power controller applies a voltage indicated by the control signal as the voltage controlling target block voltage to be applied to the voltage controlling target block, when the operation of the voltage controlling target block is normal.

3. The semiconductor device according to claim 2, wherein
the power controller outputs a new control signal to cause the power supplier to output a new one of the plurality of voltages, when the operation of the voltage controlling target block is not normal.

4. The semiconductor device according to claim 2, includes a normal operation mode and a standby mode, wherein
the voltage controlling target block outputs the error detection signals according to the plurality of voltages supplied in the normal operation mode; and
the power controller determines, based on a voltage indicated by the control signal and on the determination result from the error detector, a voltage controlling target block voltage to be supplied to the voltage controlling target block in the standby mode.

5. The semiconductor device according to claim 4, wherein
the voltage controlling target block outputs, as the error detection signal, one of signals respectively indicating different values in accordance with the plurality of voltages.

6. The semiconductor device according to claim 5., wherein
the error detector includes an expected value, and outputs the determination result showing that the operation of the voltage controlling target block is normal, when the error detection signal agrees with the expected value, and
if the determination result shows that the operation of the voltage controlling target block is normal, the power controller applies, as the voltage controlling target block voltage, a voltage indicated by the control signal.

7. The semiconductor device according to claim 4, wherein
the voltage controlling target block represents a counter which counts a standby time in the standby mode.

8. The semiconductor device according to claim 7, wherein
the voltage controlling target block supplies a count value, corresponding to one of the plurality of voltages, to the error detector, and
the error detector determines whether the count value corresponds with the expected value.

9. The semiconductor device according to claim 8, further comprising:
a detection timing generator which supplies a first timing and a second timing to the error detector, wherein
the error detector sets, as the expected value, a count value at the time when the voltage controlling target block operates normally for a period of time from the first timing to the second timing,
the error detector sets the count value supplied from the voltage controlling target block at the first timing, as a first count value,
the error detector sets the count value supplied from the voltage controlling target block at the second timing, as a second count value, and
the error detector determines whether an operation of the voltage controlling target block is normal, based on a comparison between the expected value and a difference between the first count value and the second count value.

10. The semiconductor device according to claim 4, wherein
the error detector includes in the normal operation mode:
a monitoring period when an operation of the voltage controlling target block is monitored; and
a non-monitoring period when the monitoring of an operation of the voltage controlling target block is stopped.

11. A power supplying method of a semiconductor device, comprising:
(a) instructing a power supplier to output one of a plurality of voltages;
(b) outputting an error detection signal in accordance with each of a plurality of voltages supplied from the power supplier; and
(c) determining, based on the error detection signal, a voltage controlling target block voltage supplied from the voltage controlling target block.

12. The power supplying method of the semiconductor device according to claim 11, wherein
the step (a) includes:
outputting a control signal to cause the power supplier to output one of the plurality of voltages, and
the step (c) includes:
determining, based on the error detection signal, whether an operation of the voltage controlling target block is normal,
informing the power controller of a determination result, and
determining the voltage controlling target block voltage based on a voltage indicated by the control signal, and on the determination result.

13. The power supplying method of the semiconductor device according to claim 12, wherein
the voltage controlling target block has a normal operation mode and a standby mode,
the step (b) includes:
outputting the error detection signals in accordance with the plurality of voltages supplied in the normal operation mode, and
the step (c) includes:
determining a voltage controlling target block voltage to be supplied to the voltage controlling target block in the standby mode, the voltage controlling target block voltage based on a voltage indicated by the control signal and on the determination result from the error detector.

14. The power supplying method of the semiconductor device according to claim 13, wherein
the step (b) includes:
outputting, as the error detection signal, one of signals respectively indicating different values in accordance with the plurality of voltages.

15. The power supplying method of the semiconductor device according to claim 14, wherein
the step (c) includes:
reading an expected value retained in advance,
outputting the determination result showing that an operation of the voltage controlling target block is normal, when the error detection signal corresponds with the expected value, and
applying a voltage indicating the control signal as the voltage controlling target block voltage, if the determination result shows that an operation of the voltage controlling target block is normal.

16. The power supplying method of the semiconductor device according to claim 13, wherein
the voltage controlling target block includes a counter configured to count a standby time in the standby mode, and
the step (c) includes:
setting, as the error detection signal, a count value outputted from the counter.

17. The power supplying method of the semiconductor device according to claim 16, wherein
the step (c) includes:
outputting a count value corresponding to one of the plurality of voltages, and
determining whether the count value corresponds with the expected value.

18. The power supplying method of the semiconductor device according to claim 17, further comprising:
(d) supplying a first timing and a second timing, wherein
the step (c) includes:
reading, as the expected value, a count value at the time when the voltage controlling target block operates normally for a period of time from the first timing to the second timing,
setting the count value supplied from the voltage controlling target block at the first timing, as a first count value,
setting the count value supplied from the voltage controlling target block at the second timing, as a second count value, and
determining whether an operation of the voltage controlling target block is normal, based on a comparison the expected value with a difference between the first count value and the second count value.
